(19) United States
(12) Patent Application Publication
(10) Pub. No.: US 2008/0020343 A1
(43) Pub. Date: Jan. 24, 2008

(54) DENTAL IMPLANT AND METHOD FOR MAKING AND INSTALLING SAME

(76) Inventor: K. Tim Mount, Okmulgee, OK (US)

Correspondence Address: Molly D McKay, P.C., 2301 S Sheridan-Suite A, Tulsa, OK, 74129, US

(21) Appl. No.: 11/832,213

(22) Filed: Aug. 1, 2007

Related U.S. Application Data
(62) Division of application No. 10/996,118, filed on Nov. 23, 2004.

(51) Int. Cl. A61C 13/12; A61C 5/00

(52) U.S. Cl. 433/172; 433/215

(57) ABSTRACT

A method for making a dental implant by obtaining images of the tooth pre-atraumatic tooth extraction and post extraction and using those images to computer generate and mill a titanium replacement implant employing CAD/CAM equipment. The implant includes a scalloped neck interface similar to the replaced tooth's scalloped cementoenamel junction, a polished neck area between a root portion and a crown portion, and the numeral for the tooth number imprinted on the implant's facial surface. Chevron retention fins are provided on the root portion for engaging the bone of the tooth socket or osteotomy when the implant is tapped into position. Retention grooves are provided on the crown portion to which a provisional crown is cemented slightly out of occlusion at the time the implant is placed. The provisional crown will be replaced with a permanent crown after osteointegration of the implant has occurred.

### BACKGROUND OF THE INVENTION

1. Field of the Invention

The present invention relates to a method for making a dental implant by obtaining images of the tooth pre-atraumatic tooth extraction and post extraction and using those images to computer generate and mill a titanium alloy replacement implant employing CAD/CAM equipment.

2. Description of the Related Art

Computer aided design and computer aided machining (CAD/CAM) have been employed in producing dental restorations and implant abutments. Patents already exist and the technology has been in use for a number of years for employing a three dimensional optical camera to capture an optical impression (image acquisition) of a subject tooth as well as a tooth on each side of the target tooth.

Sirona Dental Company produces the CEREC 3D, which is a CAD/CAM unit that is used at patient chairside. The unit makes an optical impression, or acquisition, of a prepared tooth and can mill a precise ceramic restoration for the tooth in less than fifteen minutes.

Atlantis Components is a company that owns U.S. Pat. Nos. 5,674,069; 5,989,029; and 6,231,342 each of which was issued to inventor Julian Osorio, the founder of the company, for essentially the same type of CAD/CAM system. At their facility they custom mill titanium abutments for dental implants that have already been placed in patients' dental arches. They use a three dimensional optical camera for image acquisition; and as in the use of the CEREC CAD/CAM mentioned previously; the computer program does most of the design work automatically. The computer operator can view the acquired three dimensional image on the monitor and, using the keyboard, trackball, and mouse keys, can modify the design prior to selecting the “mill” command which directs the machining portion of the system to mill the abutment.

A titanium alloy consisting of one part titanium, six part aluminum, and four parts vanadium, i.e. Ti-6AI-4V, represents the best solution for dental implants as well as orthopedic uses. Titanium alloy has demonstrated interfaces described as osseointegrated in humans. Biomechanical strength, biocompatibility and the modulus of elasticity are most optimal when using titanium alloy and this is the best material that biomaterials technology currently offers for tooth and skeletal replacements.

Currently surface treatment is done in the regions of the implant body where it is desired to promote bone apposition, or growth to the titanium alloy implant surface, namely the threaded portion and approximately 1-2 mm above the threads. Surface treatment can be an addition or subtraction method, and a number of coating or blasting means have been and continue to be used to achieve the desired surface treatment.

Hydroxyapatite (HA) is the principal inorganic component of bone and teeth and synthetic HA coatings are added to implants to be placed into less dense or poorer quality bone. Another enhancement method of surface treatment is the addition of a titanium oxide layer which gives texture and porosity to encourage bone growth onto and into the threaded surfaces.

Grit blasting or soluble blasting media (SBM) is a subtraction method which roughens the titanium threaded surfaces of the implant. The same is true for resorbable blast media (RBM).

The current procedure for implant replacement of a missing tooth involves essentially the following steps from surgery to restoration of the clinical crown (portion of the tooth seen when looking in the mouth—above the gum): (1) drilling an osteotomy (circular hole to a specified depth) into the alveolar bone; (2) threading the implant into the osteotomy; (3) attaching a cover screw to the implant body utilizing it's internal threads; so that the cover screw is out of occlusion with the opposing teeth (4) allowing several months for osseointegration to occur; (5) removing the cover screw; (6) placing an abutment on the implant; (7) and then restoring the abutment with a tooth colored clinical crown.

The first step of this current procedure involves drilling a circular osteotomy in the alveolar bone using an electric handpiece and associated console. The osteotomy is drilled to the depth required for the manufactured implant to be used in the treatment plan and placed in the position and angulation deemed most appropriate by the dental implant surgeon. Then the surgeon slowly threads the sterile implant into the osteotomy site. This is again done using the electric handpiece, but at a greatly reduced number of revolutions per minute over that used when creating the osteotomy.

Prior to approximately three years ago, the typical protocol was to then place a cover screw into the internal threads of the freshly placed implant body. Depending on the quality of bone, which varies in density in different regions of the maxillary (upper) and mandibular (lower) arches, the implant body, with cover screw in place, was allowed to lay dormant for three to nine months while osseointegration, or growth of bone to the titanium implant body, occurred. If bone quality was excellent, a shorter healing time was required. Conversely, if the bone quality was poorer, more healing time was required.

After osseointegration had occurred the next step was to remove the cover screw and place an abutment onto the implant body. This was done by threading a screw through the top of the abutment and into the internal threads of the implant body. Once the abutment was in place, for the first time there was something above the gingival (gum) level which resembled a tooth that had been prepared to receive a crown. Both the abutment and the implant body were made of titanium alloy.

At this point, the dentist can restore the abutment with a tooth colored clinical crown just as in the case of a natural tooth which has been prepared or reduced down to receive a new crown by use of the CEREC CAD/CAM or by traditional techniques of laboratory fabrication. The CEREC can produce the crown within fifteen minutes whereas a laboratory produced crown may require two weeks. Although most crowns are usually made of tooth colored ceramic, they alternately can be constructed of full gold or part ceramic and part gold, etc.

In the last three years or so, practitioners have begun to acquiesce to patient requests and their own desire to speed up the restoration process, and are in much larger numbers doing “immediate loading” of the freshly placed implant body. Using this new procedure, the abutment is placed on the day the implant body is threaded into the alveolar bone and usually a provisional (temporary) crown is placed that gives immediate esthetics but is not quite in function. In other words, the tooth may be slightly out of occlusion,—i.e., not touching the opposing teeth in the opposite arch. The objective is to reduce micro-movement of the implant until a reasonable amount of bone apposition has occurred.

Implants placed over approximately the last twenty years were manufactured with a circular upper platform extending just slightly above the threads or neck of the implant. This platform is a flat or horizontal table onto which the abutment seats.

One recent development is taught in U.S. Pat. Nos. 6,174,167 and 6,283,754 each of which was granted to Peter Wohrle. This development is a more natural shape to the surface treated interproximal areas (between adjacent teeth or implants) of the implant body. This is described as a scalloped implant. This scalloped implant takes account of the natural three dimensional shape of the bone surrounding the human teeth. The alveolar bone in both arches is U shaped. The maxillary arch is U shaped and the mandibular arch is an upside down U shape. To emulate nature the scalloped shape of the surface treated area occurs only between the implant and another tooth or between implants. This allows bone to grow or continue to grow in its natural shape. Implants without the scalloped areas on each side allow bone to die back approximately 1-1.5 mm. With the scalloped design, bone is allowed to keep its natural configuration in three dimensions and this supports the overlying gingival tissue. The triangular area of gingival tissue (papilla) that should exist between a tooth and an implant or between two implants is supported by bone and encouraged to grow normally in a state of health just as occurs between two teeth in a healthy mouth.

The extent or degree of scalloping depends on the individual tooth. This is merely a matter of the level at which the enamel ends and the cementum on the root of the tooth begins. It is an irregular shape going around the circumference of the tooth. The cementum on the root portion merely comes up higher between adjacent teeth and allows a triangle of bone to grow between them. As always, with nature it is the body's elegant solution to how to add support for and protect the teeth from the trauma of eating various foods. It allows for a smooth transition from the tooth enamel onto the gingival tissue in an aerodynamic manner.

A very recent development involves research into why bone dies back from the junctional connection point of the implant body with the abutment. Some practitioners and researchers in the field believe it may be due to microorganisms that gain a foothold and begin to reside on and along the finely machined connection between the implant and abutment.

Thus, the field is just seeing the introduction of new one-piece implants. The implant body and abutment are manufactured from a single piece of titanium alloy, thus eliminating any connection point. This new development meshes nicely with the fairly recent trend toward immediate loading of the combined implant and abutment with a provisional or permanent crown. The one-piece combination implant and abutment is placed in the bone and receives a crown on the same appointment.

The present invention creates a paradigm shift in patient and dental implant treatment and is a significant departure from the state of the art of current dental implant placement. It allows for custom machined and surface treated implant replacement of a tooth, with as natural an emulation of the original tooth as possible. The present procedure produces better results than previous methods by providing for immediate replacement at the time a tooth is extracted. It can also provide replacement of a previously extracted tooth. By creating a custom osteotomy and utilizating a dental database for the tooth number being replaced, an implant can be created to match this osteotomy. In the same way, it can also provide as replacement for a congenitally missing tooth.

### SUMMARY OF THE INVENTION

The present invention is a dental implant and method for making and installing that dental implant into a patient's mouth. This invention normally employs immediate implant replacement of an extracted tooth and employs prior technology such as the CEREC CAD/CAM equipment which provides the ability to acquire three dimensional images of the tooth and the CAD/CAM capability to machine titanium as is done by the Atlantis Components Company product discussed above. However, this invention can also be employed to replace teeth that have been extracted much earlier or alternately, to replace congenitally missing teeth.

Briefly, the steps in practicing the present invention when a tooth is to be immediately replaced after extraction are as follows. First, a three dimensional image of the crown of the tooth is acquired prior to extraction. The dentist then administers an anesthetic injection to prevent the patient from experiencing pain. The dentist atraumatically removes the tooth from the patient's mouth by first cutting the upper-most Sharpey's fibers with the fine blade of a periotome and then gentle luxation with extraction forceps. Next, the cementum area of the root of the tooth is cleaned of all Sharpey's fibers and the entire tooth is cleaned and dried. The tooth is then seated crown first in a tooth holder and a three dimensional image of the root structure is acquired. The images of the crown and root of the tooth are next integrated to create a composite three dimensional image of the extracted tooth on the equipment monitor. The dentist then makes any needed modifications in the computer generated implant image seen on the monitor before having the equipment mill a titanium alloy implant, which is based on the composite images acquired earlier. The milled implant will include a scalloped neck interface, polished neck area, chevron retention fins in the root portion, retention grooves and slightly abrading on the crown region, tooth number milled into the facial surface and root surface treatment, i.e. either addition or subtraction, as selected by the dentist. The dentist will decorticate and debride the tooth socket just prior to seating the newly created implant. The implant will be seated into the socket by gently tapping with a surgical mallet and utilizing a serrated tipped cylinder shaped seating instrument in contact with the implant. A provisional crown will then be cemented to the implant slightly out of occlusion. This crown will serve as an interim restoration until osseointegration of the implant can occur. Once the implant has become integrated with the patient's bone, then the provisional crown can be removed and a permanent crown cemented to the implant with the permanent crown in occlusion with the patient's opposing teeth.

A Tooth is anchored in the alveolar bone by Sharpey's fibers, collectively known as the periodontal ligament. The Sharpey's fibers run between the root of the tooth and the bone. To atraumatically remove a tooth, the upper-most Sharpey's fibers should be severed with the fine blade of a periotome prior to gentle luxation with extraction forceps. By first severing the upper-most Sharpey's fibers, many teeth can be removed from the patient's mouth very easily without breakage. Some teeth must be sectioned with a handpiece and bur before they can be removed because of multiple and/or divergent roots.

The invention requires that a three dimensional optical image be acquired of the clinical crown of the tooth prior to extraction and of the root of the tooth after it has been extracted and cleaned. Regardless of how much or how little of the original clinical crown portion remains of the tooth to be extracted, an optical acquisition should be made. The software associated with the equipment contains a dental database and can reconstruct the shape of any missing portion of the crown to a close proximity of the original shape of the missing portion of the tooth.

Current technology permits us to cut titanium by mechanical means such as burs as well as by lasers, etc. The spirit and embodiment of the invention being described encompasses any means of cutting and treating the surface of titanium alloy.

The procedure requires an infection free socket for success. The procedure requires a tooth that truly needs to be extracted and is not going to have endodontic (root canal) treatment. If there is an infection, it should be treated with antibiotics and the infection resolved prior to extraction of the tooth. Alternately, a tooth can be extracted that is infected and once the infection has abated, the patient can be brought in, the socket decorticated and thoroughly debrided of any residual ligamental attachments or epithelial tissue and have the implant placed at that time. This could occur within approximately a two week period, with the implant already milled and ready for placement based on the previously extracted tooth.

The patient must receive an anesthetic injection to have an extraction procedure done. The duration of anesthesia will be approximately 2 hours for 2% lidocaine and can be longer (up to 6 hours) depending upon the anesthetic chosen. While the patient is still anesthetized, the entire implant manufacturing and placement can occur and the crown can be placed. This entire procedure can be accomplished in one patient visit and will take approximately 1-1½ hours to complete.

Once the tooth is removed from its socket, it should have all remnants of Sharpey's fibers removed from the cementum area of the root. The tooth should be cleaned and dried and then placed crown first into a holder for root image acquisition. Although any type of holder that will hold the tooth securely will work, one type that works well is a holder that has a rubber diaphragm with an X-shaped opening cut into the diaphragm and through which the crown portion of the tooth is inserted. The tooth is seated crown first into the diaphragm down to just above where the enamel ends and the cementum begins, the cementoenamel junction (CEJ). The usual protocol of acquiring a three dimensional optical image is now completed for the root structure and this image is also stored in the computer. The extent or degree of scalloping at the CEJ depends on the individual tooth being imaged by the three dimensional camera. The immediate implant that is milled by the CAD/CAM unit will be as close a replica of the tooth that was just extracted as the technology will permit. The invention takes into consideration that we should emulate nature and create an implant with a root treated surface that is scalloped in shape just like the irregular scalloped cementum area on the root of the tooth.

Even if the tooth involved is multirooted and required sectioning, it can be bonded back together by a variety of common dental means such as using wax, acrylic, etc. If the roots are divergent, dilacerated or hooked in the apical region, i.e., curved in shaped like old fashioned ice tongs, the software takes all this into account and can design an implant replacement that can be seated back into the socket by gentle tapping with a surgical mallet and associated serrated tipped seating instrument.

The software automatically creates a random pattern of chevron retention fins on the root portion of the implant. These chevrons act somewhat like threads on conventional implants but do not create a spiral threading motion when placing the implant. They allow for bone compression as the implant seats but are one directional and will not allow the implant to come back out of the socket. This eliminates micro-movement of the implant at the time of placement and thus encourages bone growth to the titanium alloy surface treated root portion of the implant.

The dentist can rotate the three dimensional image of the proposed one-piece combination implant and abutment on the equipment monitor to check all aspects of the one-piece unit and can override the automatic computer design by eliminating a chevron or making any modification that he feels is an improvement on the computer solution. Once the dentist is satisfied with the design that is shown on the monitor, the “mill” command is selected and manufacturing of the milled implant is completed within approximately fifteen minutes.

The milled implant may not have a root portion exactly like the extracted tooth but it will be essentially the same and will be modified enough to allow it to seat to place in the patient's socket. Any voids remaining between the patient's socket and the implant after the implant has been placed will simply fill in over time with new bone growth. The implant design will not be exactly the same shape as the original tooth because if it were, the implant could not be seated to place in the socket. However, the design and milled result will have chevrons that will ensure a tight secure fit that is free from micro-movement.

The CAD system will integrate images of the root and crown portions of the tooth and produce a design that can be seated into the extraction socket; and the abutment portion will automatically be milled and ready to receive a crown on the same appointment as the extraction. As far as imaging is concerned, a before image and an after image would be the minimum required. The before image acquisition is of the tooth's crown portion prior to extraction. Normally, only one view would probably be required. However, more views could be acquired. The after image is of the root structure and could conceivably require several views, especially for a multi-rooted tooth. The software is able to map the images and integrate the data points to create a composite three dimensional image on the monitor of the entire tooth prior to milling operations.

The CAM portion of the equipment will surface treat the milled titanium alloy implant just before completion of the manufacturing process. The root portion, being analogous to the cementum area on the tooth root, will receive the chevron retention fins in a random pattern and have either an addition or subtraction surface treatment. The dentist has the option of selecting the type of surface treatment needed based on the patient's bone quality. An icon is selected to indicate this to the computer at the same time of after selecting the mill icon. The density of bone is largely dependent on the area of the mouth where the extraction was performed and is classified using Misch bone density classifications D1-D4. The clinical judgment of the practitioner comes into play in evaluating the individual patient and the extraction site and determining the appropriate surface treatment to be employed on the implant for that particular patient.

The degree of so called scalloping in the neck region of the implant will be based on duplication of the natural tooth that was just extracted, or alternately, based on a dental database if the tooth is not available for imaging in the situation of replacing a previously extracted tooth which is no longer available or a tooth that is congenitally missing. Bone is expected to grow on the surface treated root region of the implant. Directly above the surface treated root region will be a polished neck area for the region of gingival fiber formation. The gingival fiber is a circumferential band of gingival tissue that forms around the implant to provide a biologic seal. This prevents migration of bacteria and endotoxins into the underlying bone.

Directly above this polished neck area, the milling unit will produce a crown cementation region that is prepared for a crown. The region that is prepared to receive the crown will include two or more retention grooves that are automatically placed by the computer but the region can have more or less as determined by the dentist. This crown cementation region will be finished off with a slightly abraded surface as would be created with a course diamond dental cutting instrument.

The tooth number (1-32) will be placed into the facial surface (toward the lip) of this crown cementation region. The number has two functions. First, the location of the number designates the way the implant needs to be oriented while it is being seated into the patient's tooth socket. Second, the tooth number designates where the implant is to be placed in the mouth. This is important when the dentist has extracted more than one tooth and would prevent interchanging two or more similar implants.

Prior to placement of the CAD/CAM produced titanium one-piece scalloped implant, milled in the shape of the natural tooth root structure, the socket must be decorticated and principally all remnants of Sharpey's fibers must be removed. This is done using various sizes of sharp curettes which are shaped like miniature ice cream scoops. This debridement should scrape the socket bone thoroughly and create bleeding. This should be done after the implant is manufactured and just prior to seating the implant.

Once the socket has been made ready for the implant, the implant is placed in the socket so that the number on the implant corresponds with the tooth placement in the mouth and so that the surface of the implant where the number appears faces the patient's lip. Once properly positioned and oriented, the implant is then gently tapped into place with a surgical mallet utilizing a cylinder shaped serrated tipped seating instrument in contact with the implant.

A provisional crown is then cemented on the implant by traditional methods so that the crown is slightly out of occlusion with the opposing teeth. After several months when the implant becomes osseointegrated, the provisional crown can be replaced with a permanent crown that is in occlusion with the opposing teeth.

This method can also be used to replace a tooth that was previously extracted months or years earlier. When using the present method to replace a previously extracted tooth, the dentist uses the same basic procedure as described previously for a tooth that is extracted and immediately replaced with an implant. In this situation, the dentist creates an osteotomy at the site where a tooth had been removed months or years earlier. The surgeon can generate a custom milled single or multi-rooted titanium alloy implant via the CAD/CAM system by means of traditional precision impression making. After a single rooted or multi-rooted osteotomy with a common alveolar bone and gingival tissue opening has been created, a traditional technique of precision impression making is completed for the osteotomy. This renders an exact negative replica of the osteotomy form that has been created.

The surgeon treats this impression much like the extracted tooth and makes a three dimensional optical acquisition of it. The same computer and dentist design options are exercised and then the titanium alloy is milled as a one-piece combination implant and abutment. The same chevron retention fins are created on the implant body as taught above along with the scalloping of the interdental areas just as found in natural teeth. The topography of the tooth's crown portion, the scalloping pattern and the abutment configuration will come from a standard dental database and will be based on the tooth number being replaced. As previously described above, this composite image can be modified by the dentist based on clinical judgment regarding the patient's needs.

The so called scalloped interproximal areas on the custom implant will encourage bone growth between the implant and adjacent teeth or between adjacent implants. Even if bone does not exist at the time of such implant placement, bone grafting can be done to promote the proper natural anatomical osseous form and thus formation of a natural overlying gingival tissue between the teeth and/or implants. Therefore, the triangular shaped natural papilla is encouraged to grow between the teeth and/or implants just as is found in the normal healthy mouth.

Not only does the present system allow for replacement of a missing tooth that may have been recently extracted or may have been missing for many years, it also allows for placement of an implant where there is a congenitally missing tooth. It allows the dentist to be in complete control of the depth, size, and overall shape of the osteotomy. As noted, the osteotomy can be created as single or multi-rooted. The only criterion is that the computer and the dentist design and ultimately manufacture a custom implant that can be tapped to place using a surgical mallet and seating instrument in contact with the implant.

The osteotomy created for the missing tooth does not necessarily need to be, nor should it be, circular in nature. The invention takes into account that the dentist can create an osteotomy site that is as much like the natural tooth root shape and size as the available bone will permit. Also, the cervical area where the implant emerges through the alveolar bone can and should be as much like the anatomical shape and size of the natural missing tooth as available bone permits. This not only requires use of the traditional circular osteotomy drills but requires a variety of bone milling and grinding burs that can be in an array of shapes and sizes.

### BRIEF DESCRIPTION OF THE DRAWINGS

FIG. 1 is a perspective view of an upper tooth that is to be removed from a patient's mouth while a CAD/CAM unit is being employed to obtain a three dimensional image of the clinical crown prior to extraction of the tooth.

FIG. 2 is the tooth of FIG. 1 shown with an anesthetic syringe being used to administer a local anesthetic injection to the patient's mouth to prevent the feeling of pain.

FIG. 3 is the tooth of FIG. 2 shown with a periotome blade being used to cut, or sever, the upper-most Sharpey's fibers that surround the tooth and secure the tooth to the bone.

FIG. 4 is the tooth of FIG. 3 shown after it has been removed from its socket in the patient's mouth and has been cleaned of Sharpey's fibers.

FIG. 5 is the tooth of FIG. 4 shown inserted upside down into a tooth holder and a three dimensional image is being made of the root of the tooth employing a CAD/CAM unit.

FIG. 6A is a composite image of the proposed implant as it appears on the CAD/CAM unit monitor.

FIG. 6B is an enlarged view of the proposed implant of FIG. 6A.

FIG. 6C is an enlarged view of one of the chevron fins contained within the broken circle of FIG. 6B.

FIG. 6D is a side view of the proposed implant taken along line 6D-6D.

FIG. 7 is the milled and root surface treated implant that has been created by the CAD/CAM unit and that is now ready for implantation into the patient's tooth socket.

FIG. 8 shows the tooth socket that has been decorticated and debrided just prior to seating the newly created implant.

FIG. 9 shows the implant being secured in the tooth socket.

FIG. 10 shows a provisional crown that has been placed on the implant.

### DETAILED DESCRIPTION OF THE PREFERRED EMBODIMENT THE INVENTION

Referring now to the drawings and initially to FIG. 1, there is shown a tooth 10 that is about to be extracted from a tooth socket 12 in a patient's mouth 14 and, as shown in FIG. 10, replaced with an implant 16 according to a preferred embodiment of the present invention. The present invention is a dental implant 16 and method for making and installing that dental implant 16 into a patient's mouth 14.

This invention normally involves replacement of a tooth 10 with an implant 16 immediately after the tooth 10 is extracted. The process employs prior technology such as the CEREC CAD/CAM equipment that is illustrated in FIGS. 1, 5, and 6A. This CAD/CAM equipment 18 provides the ability to acquire three dimensional images of the tooth 10 via a camera 18B that is part of the equipment 18 and the capability to machine a titanium implant 16. However, this invention can also be employed to replace a tooth or teeth that have been extracted much earlier, or alternately, to replace congenitally missing teeth. The drawings provided are designed to illustrate the extraction and immediate replacement of a tooth 10. The procedure for replacing previously extracted teeth and congenitally missing teeth will be described following a detailed discussion of the procedure for immediate replacement of an extracted tooth 10.

Briefly, the steps in practicing the present invention when a tooth 10 is to be immediately replaced after extraction are as follows. First, as illustrated in FIG. 1, a three dimensional image of the clinical crown portion 20 of the tooth 10 is acquired prior to extraction employing the CAD/CAM equipment 18. This three dimensional image is stored in the equipment 18 and will later be used to help create an implant 16 that will replace the tooth 10. It is desirable to obtain a three dimensional optical image of the clinical crown portion 20 of the tooth 10 prior to extraction and of the root 28 of the tooth 10 later after the tooth 10 has been extracted and cleaned. Regardless of how much or how little of the original crown portion 20 remains of the tooth 10 to be extracted, an optical acquisition should be made. The software associated with the equipment 18 contains a dental database and can use that database to reconstruct the shape of any missing part of the crown portion 20 to a close proximity to the original shape of the missing part of the tooth 10.

The present procedure requires an infection free tooth socket 12 for success. The present procedure requires a tooth 10 that truly needs to be extracted and is not going to have endodontic treatment. If there is an infection, the infection should be treated with antibiotics and the infection resolved prior to extraction of the tooth 10. Alternately, a tooth 10 that is infected can be extracted and once the infection has abated, the patient can be brought in, the socket decorticated and thoroughly debrided of any residual ligamental attachments or epithelial tissue and have the implant 16 placed at that time, according to the process that will be more fully explained hereafter. If the tooth is infected at the time of extraction and it is therefore necessary to wait until the infection has subsided, the implant 16 normally will be placed within approximately a two week period following extraction of the tooth 10, with the implant 16 already milled and ready for placement based on the previously extracted tooth 10.

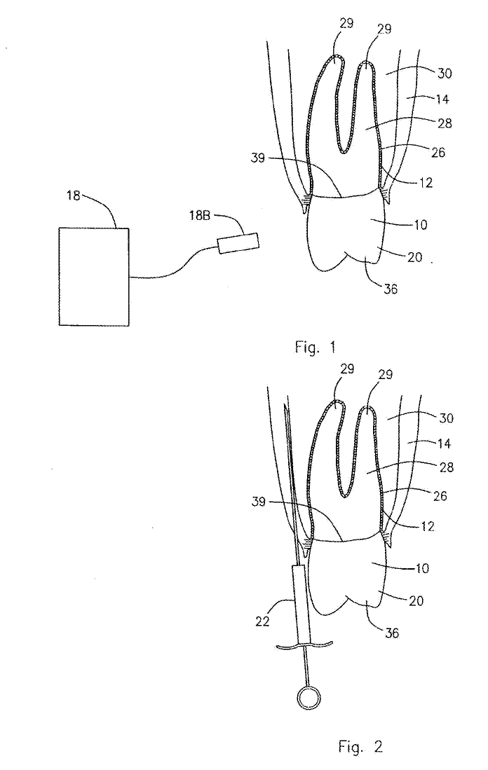

Once a three dimensional image of the clinical crown portion 20 of the tooth 10 has been obtained, the dentist then uses an anesthetic syringe 22 to administer an injection to the patient's mouth 14 to prevent the sensation of pain, as shown in FIG. 2. The patient must receive an anesthetic injection to have the extraction procedure done. The duration of anesthesia will be approximately 2 hours for 2% lidocaine and can be longer (up to 6 hours) depending upon the anesthetic chosen. While the patient is still anesthetized, the entire manufacturing and placement of the implant 16 can occur and a provisional crown 48 can be placed. This entire procedure can be accomplished at one patient appointment visit and will take approximately 1-1½ hours to complete.

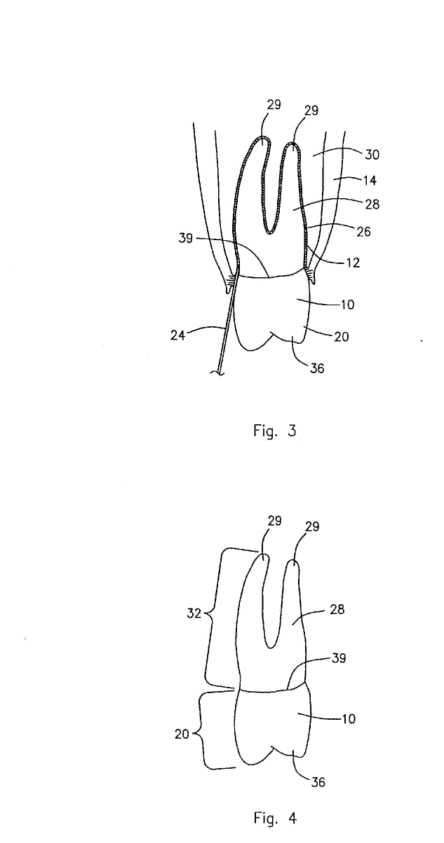

Then, as shown in FIG. 3, the dentist atraumatically removes the tooth 10 from the patient's mouth 14. A tooth 10 is anchored in the bone 30 by Sharpey's fibers 26, collectively known as the periodontal ligament. The Sharpey's fibers 26 run between the root 28 of the tooth 10 and the bone 30. By first severing the upper-most Sharpey's fibers 26, many teeth 10 can be removed from the patient's mouth 14 very easily without breakage. Thus, to atraumatically remove a tooth 10, the dentist will generally first use a periotome 24. Once those Sharpey's fibers 26 that can be reached with a periotome 24 have been severed, the dentist then gently luxates the tooth 10 with extraction forceps. If the tooth 10 must be sectioned in order to remove it, then the tooth 10 can be bonded back together after it has been cleaned and dried in order to obtain the necessary image of the root 28, as will be more fully described hereafter.

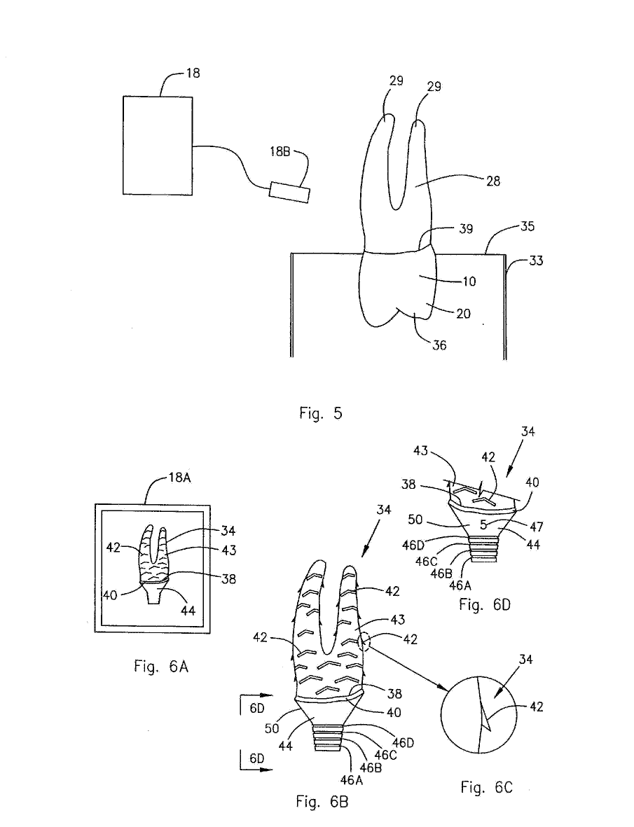

As illustrated in FIG. 4, after the tooth 10 has been removed from the patient's mouth 14 leaving an empty tooth socket 12 in the mouth 14, the cementum area 32 of the root 28 of the tooth 10 is cleaned of all Sharpey's fibers 26. The cleaned tooth 10 is then dried of surface moisture. The clean, dry tooth 10 is then seated crown first in an appropriate tooth holder 33 so that a three dimensional image of the root structure 28 of the tooth 10 can be acquired, as shown in FIG. 5.

Even if the tooth 10 involved is multi-rooted and required sectioning to remove it from the patient's mouth 14, the tooth 10 can be bonded back together by a variety of common dental means such as using wax, acrylic, etc. If the roots 28 are divergent, dilacerated or hooked in the apical region 29 the software employed by the CAD/CAM equipment 18 takes this into account and can design an implant 16 replacement that can be seated back into the tooth socket 12 by gentle tapping with a surgical mallet (not illustrated) and cylinder shaped serrated tipped instrument (not illustrated) in contact with the implant. Many common dental instruments, even the handle of a mouth mirror (with the mirror portion unscrewed), could serve as the seating instrument in contact with the implant. However, any such seating instrument should be made of titanium to prevent dissimilar metal contamination. Any small surgical mallet would also serve well in the seating process.

Although any type of holder 33 that will hold the tooth 10 securely will work, one type that works well is the holder 33 that is illustrated in FIG. 5. This holder 33 has a rubber diaphragm 35 into which an X-shaped opening has been cut. The crown portion 20 of the tooth 10 is inserted through the X-shaped opening in the diaphragm 35. The tooth 10 is seated crown portion 20 first into the diaphragm 35 down to just above where the enamel 36 ends and the cementum area 32 begins i.e., the cementoenamel junction or CEJ which is indicated in the drawings in association with numeral 39.

The extent or degree of scalloping at the CEJ 39 depends on the individual tooth 10 being imaged by the three dimensional camera 18B. The implant 16 that is immediately milled by the CAD/CAM unit 18 will be as close a replica of the original tooth 10 that was just extracted as current technology will permit. The present invention takes into consideration that nature should be emulated by creating an implant 16 with a surface treated root 43 that is provided with a scalloped shaped CEJ 39 just like the irregular scalloped interface between the cementum area 32 on the root 28 of the tooth 10 and the enamel 36 of the crown portion 20 of the tooth 10.

The usual protocol of acquiring a three dimensional optical image is now completed for the root 28 of the tooth 10 and this image is also stored in the CAD/CAM computer 18.

The acquired images of the crown portion 20 and the root 28 of the tooth 10 are next integrated by the CAD portion of unit 18 to create a composite three dimensional image of the proposed implant 34 that appears on monitor 18A provided on the equipment 18, as shown in FIG. 6A. Normally at least one before-extraction image of the clinical crown portion 20 of the tooth 10 would be obtained prior to extraction of the tooth 10 and also at least one after-extraction image of the root 28 of the tooth 10 would be obtained. However, it may be desirable to acquire more views, particularly if the tooth 10 has multiple roots 28.

The CAD system 18 will integrate the images and produce the image of a proposed design 34 for an implant 16 that would be suitable to be seated into the extraction socket 12. The dentist can rotate the three dimensional image 34 of the proposed one-piece combination implant and abutment 34 on the monitor screen 18A of the equipment 18 to check all aspects of the proposed one-piece implant and can override the automatic computer generated design by eliminating a retention fin 42 or making any modification that he feels is an improvement on the computer solution. Once the dentist is satisfied with the design image 34 that is shown on the monitor 18A, he selects the “mill” command on the equipment 18 and manufacturing of the milled titanium implant 16 is completed within approximately fifteen minutes based on the final composite image 34. The implant 16 will include a crown region 44 that is ready to receive a clinical provisional crown 48 on the same appointment as the extraction. Current technology permits a titanium implant 16 to be cut by mechanical means such as burs, lasers, etc. The present invention encompasses any means of cutting or creating the implant 16.

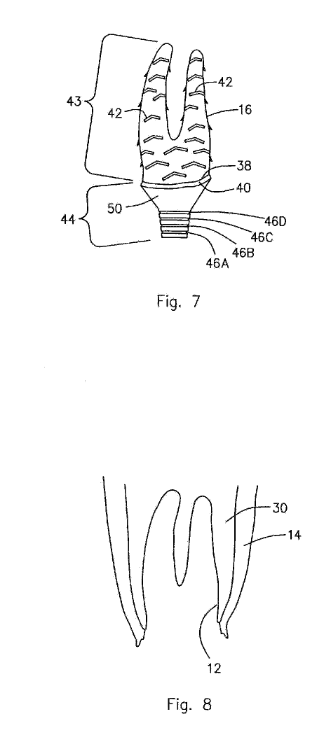

As illustrated in FIGS. 6B, 6C, 6D, and 7, the milled implant 16 will include a scalloped neck interface 38 that duplicates the scalloped contours found on the tooth 10 that the implant 16 is to replace. The degree of scalloping in the neck interface 38 will preferably be a duplication of the scalloping found on the natural tooth 10 that was just extracted. Alternately, the degree of scalloping will be based on a dental database if the tooth 10 is not available for imaging, as is the case when replacing a previously extracted tooth 10 that is no longer available to the dentist or when replacing a tooth 10 that is congenitally missing. Bone is expected to grow on the surface treated root portion 43 of the implant 16.

The scalloped interproximal areas or scalloped neck interface 38 on the custom implant 16 will encourage bone growth between the implant 16 and adjacent teeth or between adjacent implants 16. Even if bone 30 does not exist at the time of the implant 16 is placed in the patient's mouth 14, bone grafting can be done to promote the proper natural anatomical osseous form and thus formation of a natural overlying gingival tissue between the teeth and/or implants 16. Therefore, the triangular shaped natural papilla is encouraged to grow between the teeth and/or implants 16 just as is found in the normal healthy mouth 14.

Directly above the surface treated root region 43 will be a polished neck area 40 for the region of gingival fiber formation and attachment to the implant 16. Although not illustrated, the gingival fiber is a circumferential band of gingival tissue that forms around the implant 16 to provide a biologic seal for the implant 16. The gingival fiber helps to prevent migration of bacteria and endotoxins into the underlying bone 30.

The software of the CAD/CAM equipment 18 automatically creates a random pattern of chevron-shaped retention fins 42 on the root portion 43 of the implant 16. As shown in detail in FIG. 6C, the retention fins 42 are angled in the direction of the crown region 44 of the implant 16 so that when the implant 16 is installed in the patient's mouth 14, the fins 42 engage the bone 30 and secure the implant 16 to the bone 30. These chevron-shaped retention fins 42 act somewhat like the threads provided on conventional implants but instead do not create a spiral threading motion when placing the implant 16. The retention fins 42 allow for compression of the bone 30 surrounding the tooth socket 12 as the implant 16 seats and because they are one directional, will not allow the implant 16 to come back out of the socket 12. This eliminates micro-movement of the implant 16 at the time of placement and thus encourages bone growth to the titanium alloy, surface-treated root portion 43 of the implant 16.

Directly above the polished neck area 40 on the implant 16 will be provided a crown cementation region 44 that is prepared for a crown 48. The crown region 44 will include two or more retention grooves 46A, 46B, 46C and 46D that are automatically placed circumferentially on the crown region by the equipment 18. The number of retention grooves 46A, 46B, 46C and 46D can be determined by the dentist.

This crown cementation region 44 will be finished off with a slightly abraded surface as would be created with a course diamond dental cutting instrument. The abrading allows a crown 48 to be more securely attached thereto.

A tooth number 47 is also milled into the facial surface 50 i.e., on the surface of the implant that faces the patient's lip, of the crown region 44 of the implant 16. The tooth number 47 is assigned according to the standard tooth numbering system employed in dentistry i.e., employing tooth numbers 1-32. The tooth number 47 serves two functions. First, the location of the tooth number 47 on the facial surface 50 of the implant 16 designates the way the implant 16 needs to be oriented while the implant 16 is being seated into the patient's tooth socket 12. Second, the tooth number 47 indicates the location within the patient's mouth 14 where the tooth 10 was originally located and where the implant 16 will be installed. The tooth number 47 of the implant 16 is particularly important when the dentist is working with a patient who has had more than one tooth extracted to prevent the dentist from accidentally getting the implants interchanged. The tooth number 47 will later be concealed by a crown 48 which will cover the crown region 44.

The CAD/CAM equipment will surface treat the root portion 43 of the milled titanium alloy implant 16 at the completion of the implant manufacturing process. The surface treatment with be either of an addition type or of a subtraction type, as selected by the dentist. The root portion 43 of the implant 16 is analogous to the cementum area 32 on the tooth's root 28. It will receive the chevron retention fins 42 in a random pattern and will receive an appropriate surface treatment. The surface treatment that the dentist selects will be based on the quality of the patient's bone 30. The density of bone 30 is largely dependent on the area of the mouth 14 where the extraction was performed and is classified using Misch bone density classifications D1-D4. The clinical judgment of the practitioner comes into play in evaluating the individual patient and the extraction site and determining the appropriate surface treatment to be employed on the implant 16 for that particular patient. The present invention includes any type of surface treatment of the root portion 43. The surface treatment is designed to encourage growth of bone 30 around the implant 16 i.e., osseointegration of the implant 16.

The milled implant 16 may not have a root portion 43 exactly like the root 28 of the extracted tooth 10 but it will be essentially the same and will be modified enough to allow it to seat to place in the patient's socket 12. Any voids remaining between the patient's socket 12 and the implant 16 after the implant 16 has been placed will simply fill in over time with new bone growth. The design of the implant 16 will not be exactly the same shape as the original tooth 10 because if it were, the implant 16 could not be seated to place in the socket 12. However, the designed and milled implant 16 will have its chevron-shaped retention fins 42 that will ensure a tight secure fit with the bone 30 that is free from micro-movement.

As illustrated in FIG. 8, just prior to seating the new implant 16 in the tooth socket 12, the dentist will first decorticate the tooth socket 12 to remove principally all remnants of Sharpey's fibers 26. This is done using various sizes of sharp curettes which are shaped like miniature ice cream scoops. After decorticating the tooth socket 12, the dentist will next debride the tooth socket 12. This debridement should scrape the socket bone 30 thoroughly and create bleeding. This final step should be done after the implant 16 is manufactured and just prior to seating the implant 16.

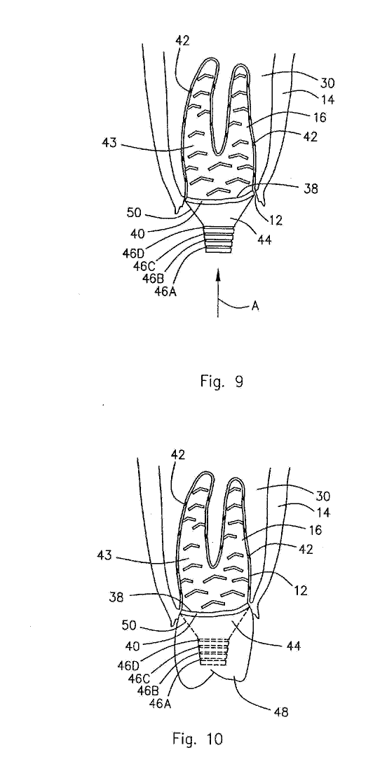

Also, the implant 16 will be sterilized prior to installation. Then, as shown in FIG. 9, the new implant 16 will be placed in the socket 12 of the tooth number 47 appearing on the implant 16 with the tooth number 47 facing the patient's lip. Finally, the implant 16 is secured into the socket 12 by gently tapping a seating instrument held firmly against the implant using a surgical mallet until the implant 16 is installed at the proper depth within the socket 12. Tapping the implant 16 with a seating instrument against the implant and using a surgical mallet is indicated by arrow A in FIG. 9

Finally, as illustrated in FIG. 10, a provisional crown 48 will then be secured to the crown region 44 by cementation so that the provisional crown 48 is slightly out of occlusion with the opposing teeth. This provisional crown 48 will stay in place until osseointegration of the implant 16 can occur. Osseointegration can take several months.

Once the implant 16 has become integrated with the patient's bone 30, then the provisional crown 48 can be removed and a permanent crown (not illustrated) can be secured to the implant as a replacement for the provisional crown 48. The permanent crown will be placed in occlusion with the patient's opposing teeth (not illustrated) according to traditional methods.

This method can also be used to replace a tooth 10 that was previously extracted months or even years earlier. When using the present method to replace a previously extracted tooth 10, the dentist uses the same basic procedure as described previously for a tooth 10 that is extracted and immediately replaced with a sterilized implant 16. However, in this situation, the dentist creates an osteotomy or artificial tooth socket 12 at the site where the tooth 10 had been removed months or years earlier. After a single rooted or multi-rooted osteotomy 12 with a common alveolar bone and gingival tissue opening has been created, a traditional technique of precision impression making is completed on the osteotomy 12. This renders an exact negative replica of the osteotomy form that has been created.

The surgeon treats this impression much like the extracted tooth 10 and makes a three dimensional optical acquisition of it. The same computer and dentist design options are exercised as previously described above and then the titanium alloy is milled as a one-piece combination implant and abutment 16. The same chevron retention fins 42 are created on the implant 16 as taught above along with the scalloping of the neck interface in the interdental areas 38 just as found in natural teeth. The topography of the tooth's crown portion 20, the scalloping pattern of the cementoenamel junction 39 and the abutment configuration of the crown region 44 of the implant 16 will come from a standard dental database and will be based on the tooth number being replaced i.e., tooth number 1-32. As previously described above, the computer generated composite image 34 can be modified by the dentist based on clinical judgment regarding the patient's needs.

The present system can also be employed to install an implant 16 in a patient's mouth 14 where there is a congenitally missing tooth. It allows the dentist to be in complete control of the depth, size, and overall shape of the osteotomy or artificially produced tooth socket 12. As noted, the osteotomy 12 can be created as single or multi-rooted. As outlined previously, the computer generates an implant design 34 that can be seated in the osteotomy site 12. The dentist can make limited modifications such as adding or removing chevron retention fins 42. He also selects the addition or subtraction method of surface treatment for the root portion 43 of the implant 16. The same method of seating the previously sterilized implant 16 into the osteotomy 12 is used as noted previously i.e., using a seating instrument in contact with the implant and gentle tapping with a surgical mallet.

The osteotomy 12 created for the missing tooth does not necessarily need to be, nor should it be, circular in nature. The invention takes into account that the dentist can create an osteotomy site 12 that is as much like the shape and size of a natural tooth root 28 as the available bone 30 will permit. Also, the cervical area of the osteotomy 12 where the implant 16 emerges through the alveolar bone 30 can and should be as much like the anatomical shape and size of the natural missing tooth 10 as available bone 30 permits. This not only requires use of traditional circular osteotomy drills but requires a variety of bone milling and grinding burs that can be in an array of shapes and sizes.

Also, because the osteotomy 12 was created by the dentist, there is no need to decorticate the osteotomy prior to installing the implant 16 since the osteotomy 12 will not contain any Sharpey's fibers 26. However, the normal procedure of debriding the osteotomy 12 prior to installing the implant 16 should be performed.

While the invention has been described with a certain degree of particularity, it is manifest that many changes may be made in the details of construction and the arrangement of components without departing from the spirit and scope of this disclosure. It is understood that the invention is not limited to the embodiments set forth herein for the purposes of exemplification, but is to be limited only by the scope of the attached claim or claims, including the full range of equivalency to which each element thereof is entitled.

What is claimed is:

1. A method for making a dental implant comprising:
generating by use of CAD/CAM equipment at least one three dimensional image of the crown portion of a tooth that is to be replaced and at least one three dimensional image of the cleaned and dried root of the tooth that is to be replaced,
integrating the images of the tooth to create an image of a proposed one-piece implant to be used to replace the tooth,
using the image of the proposed one piece implant to mill an implant from titanium alloy, and
surface treating the root portion of the implant.

2. A method for making a dental implant according to claim 1 further comprising:
modifying the image of the proposed one piece implant to better fit the patient's bone quality and quantity and selecting the desired surface treatment for the root portion of the implant after the images of the tooth have been integrated to create an image of the proposed one piece implant and prior to milling the implant.

3. A method for installing a dental implant comprising:
gently tapping a sterilized one piece dental implant into a tooth socket or osteotomy that was decorticated and debrided just prior to seating the implant so that retention fins provided on a root portion of the implant engage bone and the implant is seated in the proper orientation and to the proper depth, and
securing a provisional crown slightly out of occlusion with the patient's opposing teeth to a crown region of the implant so that retention grooves provided circumferentially on the crown region help to retain the provisional crown.

4. A method for installing a dental implant according to claim 3 wherein the provisional crown is milled by the CAD/CAM equipment to fit onto the crown region of the implant and to simulate the shape of the natural crown portion for the tooth that the implant is to replace.

5. A method for installing a dental implant according to claim 3 further comprising:
allowing osseointegration of the implant to occur, and
replacing the provisional crown on the crown region with a permanent crown that is in occlusion with the patient's opposing teeth.

6. A method for installing a dental implant according to claim 3 wherein the permanent crown is milled by the CAD/CAM equipment to fit onto the crown region of the implant and to simulate the shape of the natural crown portion for the tooth that the implant is to replace.

7. A method for making and installing a dental implant to replace a tooth that is to be extracted or has recently been extracted and where the extracted tooth is available to the dentist comprising:
generating by use of CAD/CAM equipment at least one three dimensional image of the crown portion of a tooth that is to be replaced prior to extraction of the tooth from a patient's mouth,
removing the tooth atraumatically from its associated tooth socket by first severing the upper-most Sharpey's fibers from the cementum area of the root with a periotome and then gently luxating the tooth,
cleaning the root of the extracted tooth of all Sharpey's fibers and drying the cleaned tooth,
generating by use of CAD/CAM equipment at least one three dimensional image of the root of the extracted tooth,
integrating the images of the crown portion and the root portion of the tooth to produce a three dimension image of a proposed implant to replace the tooth,
modifying the image of the proposed implant to correlate with the bone quality and quantity of the patient and selecting a surface treatment for the root portion of the implant,
milling the implant by use of the CAD/Cam equipment and applying the selected surface treatment to the root portion of the implant,
decorticating and debriding the tooth socket just prior to seating the implant, and
seating the previously sterilized implant to the proper depth by gently tapping the implant into the tooth socket so that a numeral on the crown region of the implant faces the patient's lip and the numeral on the implant matches the tooth number location of the tooth that is being replaced, and
securing a provisional crown slightly out of occlusion with the patient's opposing teeth to the crown region of the implant so that retention grooves provided circumferentially on the crown region help to retain the provisional crown on the crown region.

8. A method for making and installing a dental implant according to claim 7 further comprising:
allowing osseointegration of the implant to occur, and
replacing the provisional crown on the crown region of the implant with a permanent crown that is in occlusion with the patient's opposing teeth.

9. A method for making and installing a dental implant to replace a congenitally missing tooth or a tooth that has previously been extracted and where the extracted tooth is not available to the dentist comprising:
creating an osteotomy in a patient's mouth to receive a dental implant,
making an impression of the osteotomy,
generating by use of CAD/CAM equipment at least one three dimensional image of the impression of the osteotomy,
integrating the images of the impression of the osteotomy with data from a standard database on human teeth crown morphology to produce a three dimension image of a proposed implant to be installed in the osteotomy,
modifying the image of the proposed implant to match the bone quality and quantity of the patient and selecting a surface treatment for the root portion of the implant,
milling the implant by use of the CAD/CAM equipment and applying the selected surface treatment to the root portion of the implant,
debriding the new osteotomy just prior to seating the implant,
seating the previously sterilized implant to the proper depth by gently tapping the implant into the osteotomy so that a numeral on the crown region of the implant faces the patient's lip and the numeral on the implant matches the tooth number location of the missing tooth that is being replaced, and
securing a provisional crown slightly out of occlusion with the patient's opposing teeth to the crown region of the implant so that retention grooves provided circumferentially on the crown region help to retain the provisional crown on the crown region.

10. A method for making and installing a dental implant according to claim 9 further comprising:
allowing osseointegration of the implant to occur, and
replacing the provisional crown on the crown region of the implant with a permanent crown that is in occlusion with the patient's opposing teeth.
